(19) United States
(12) Patent Application Publication
(10) Pub. No.: US 2011/0122222 A1
(43) Pub. Date: May 26, 2011

(54) ACTIVE DISPLAY STANDBY MODE SYSTEM AND METHOD

(75) Inventors: Mark Francis Rumreich, Indianapolis, IN (US); Poh Chua, Fairfax, VA (US); Scott Baxter, Carmel, IN (US); Thomas Dale Yost, indianapolis, IN (US)

(73) Assignee: Shenzhen TCL New Technology LTD, Shenzhen (CN)

(21) Appl. No.: 12/674,838

(22) PCT Filed: Sep. 28, 2007
(86) PCT No.: PCT/US07/79923

§ 371 Date: Feb. 23, 2010

(30) Foreign Application Priority Data
Sep. 13, 2007 (CN) CN200710077094.2

(51) Int. Cl. G09G 5/00; H04N 5/66; H04N 7/15

(52) U.S. Cl. 348/14.08; 345/212; 348/739; 348/E07.083; 348/E05.133

(57) ABSTRACT

An exemplary electronic device comprises a display subsystem that is adapted to display an image and at least one additional subsystem. The exemplary electronic device additionally comprises a low power control logic that is adapted to place the electronic device in either a low power operating mode in which power is removed from the display subsystem and the at least one additional subsystem or an active-display standby mode in which the display subsystem remains powered and power is removed from the at least one additional subsystem.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many televisions are now supporting a low power operating mode to conserve power when they are not turned on. To implement this low power mode, many television designs incorporate a low power microcontroller that is separate from the system's main processor. In such designs, the low power microcontroller remains powered during the low power operating mode, while other major subsystems in the television, including the system processor, the display subsystem and the audio subsystem, are powered down. The low power microcontroller is typically responsible for powering the TV on when the user presses the “power on” button on the remote control or front panel. Other than providing a state of readiness, the low power operating mode provides no usefulness to the consumer.

### BRIEF DESCRIPTION OF THE DRAWINGS

In the drawings:

FIG. 1 is a block diagram of an electronic device that may employ an exemplary embodiment of the present invention; and

FIG. 2 is a process flow diagram illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention relates to an electronic device that supports an active-display standby mode. The active-display mode may become enabled when the electronic device is turned off, allowing a user to display images or video from a variety of sources other than broadcast signals. The hours of operation for the active-display mode may be selected by the user. In an exemplary embodiment of the present invention, a typical low power operating mode is enabled when the electronic device is turned off and the active-display standby mode is not enabled. In addition, power consumption and lamp life may be conserved in the active-display mode, as compared to normal television viewing.

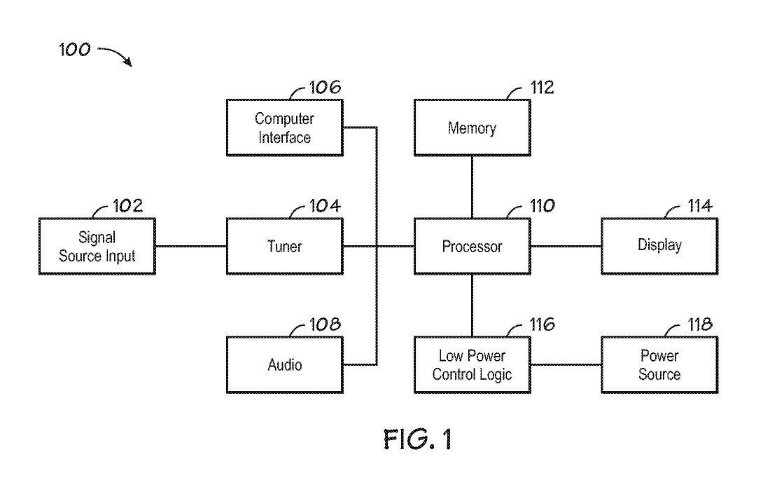

FIG. 1 is a block diagram of an electronic device that may employ an exemplary embodiment of the present invention. The electronic device is generally referred to by the reference number 100. The electronic device 100 (for example, a television, a portable DVD player or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

A signal source input 102 may comprise an antenna input, an RCA input, an S-video input, a composite video input or the like. Those of ordinary skill in the art will appreciate that, although only one signal source is shown, the electronic 100 may have multiple signal source inputs. The signal source input 102 is adapted to receive a signal that comprises video data and, in some cases, audio data. The signal received by the signal source input 102 may comprise a broadcast spectrum (e.g., if the signal source input 102 comprises an antenna) or a single channel of video and/or audio data (e.g., if the signal source input 102 comprises a DVD player or the like).

A tuner subsystem 104 is adapted to tune a particular video program from a broadcast signal received from the signal input source 102. Those of ordinary skill in the art will appreciate that input signals that are not received as part of a broadcast spectrum may bypass the tuner 104 because tuning is not required to isolate a video program associated with those signals.

A computer interface 106 may comprise a wireless network connection, an Ethernet connection, a Universal Serial Bus (USB) connection or any other suitable connection that allows the electronic device 100 to communicate with an external computer system. As discussed below, the computer interface 106 may be used to deliver video content for display by the electronic device 100.

The electronic device 100 may include an audio subsystem 108. The audio subsystem 108, which may comprise an audio amplifier, may be adapted to play audio data associated with video data being displayed by the electronic device 100.

A processor 110 is adapted to control the overall operation of the electronic device 100. A memory 112 may be associated with the processor 110 to hold machine-readable computer code that causes the processor 110 to control the operation of the electronic device 100. A display subsystem 114 may comprise a liquid crystal (LCD) display, a liquid-crystal-on-silicon (LCOS) display, a digital light projection (DLP) display or any other suitable display type. The display subsystem 114 may include a lighting source (not shown) that is used to generate a visible image on the display.

In an exemplary embodiment of the present invention, a low power control logic 116 is adapted to provide power from a power source 118 to the various subsystems of the electronic device 100. In an exemplary embodiment of the present invention, the low power control logic 116 supports operation of the electronic device 100 in a low power operating mode. In the low power operating mode, power is removed from all major subsystems of the electronic device 100. Specifically, in low power operating mode of an exemplary embodiment, power is removed from the tuner subsystem 104, the audio subsystem 108, the processor 110 and the display subsystem 114, including its associated light source.

The low power control logic 116 may be further adapted to detect when a user desires to turn on the electronic device 100 and restore power to the needed subsystems so that the electronic device 100 may operate in a normal manner. For example, the low power control logic 116 may be adapted to receive an “ON” command from a remote control and return power from the power source 118 to all subsystems of the electronic device 100 in response thereto. By supporting the low power operating mode, the electronic device 100 may save energy and may comply with one or more power management standards such as the Energy Star standard.

In an exemplary embodiment of the present invention, the low power control logic 116 supports an active-display standby mode, which is an intermediate step between normal operation (i.e., all device subsystems powered) and low power operating mode (i.e. all major device subsystems unpowered). In the active-display standby mode, power is not removed from the display subsystem 114 or its associated light source. Other subsystems such as the tuner subsystem 104, the audio subsystem 108 or the processor 110 may have power removed in the active-display standby mode if those subsystems are not needed for the display of video data from an alternative source. Moreover, the active-display standby mode enables the display subsystem 114 to operate as a monitor to display video data from a source other than a typical broadcast signal. For example, the display subsystem 114 may receive and display a video signal via the signal source input 102 or the computer interface 106 when in the active-display standby mode.

Examples of video data that may be displayed by the display subsystem 114 in active-display standby mode include digital photos stored in the electronic device 100 or in an external device such as a Universal Serial Bus (USB) dongle, a secure digital (SD) memory card or the like. Other examples of video data that may be displayed in the active-display standby mode include a closed-circuit television feed, a feed from one or more wireless cameras (e.g., a video baby monitor, which may be connected via the computer interface 106) or a feed from a camera in a remote location (for example, via the Internet). Still other examples of video data that may be displayed by the display subsystem 114 in the active-display standby mode include video conferencing (e.g., Skype), progress of on-going video games being played elsewhere, or other information such as weather data or the like. Moreover, any video data may be displayed in active-display standby mode so long as the display of that video data does not require the operation of a device subsystem that is not powered in the active-display standby mode.

In an exemplary embodiment of the present invention, the low power control logic 116 of the electronic device 100 is adapted to determine whether power may be removed from certain device subsystems depending on the video source or content that is being displayed in the active-display standby mode. For example, if the video being displayed in the active-display standby mode does not have a corresponding audio channel, the low power control logic 116 may remove power from an audio subsystem of the electronic device 100. Additionally, power may be removed from the tuner subsystem 104 or other device subsystems that are not required to display a particular type of video in the active-display standby mode.

In an exemplary embodiment of the present invention, the hours during which the electronic device 100 supports the active-display standby mode may be selected by the user. For example, the user may choose to have the active-display standby mode operational during weekday evenings. At other times when not in use, the electronic device 100 would enter the low power operating mode. In this manner, the user may use the electronic device 100 to display other content when it is convenient, while taking advantage of the power savings afforded by low power operating mode at other times when the electronic device 100 is not in use.

An exemplary embodiment of the present invention may allow the user to select energy and lamp-life conserving options such as dimming the LCD backlight. A light sensor or motion sensor may optionally be used to further enhance energy savings by reducing the backlight in dark ambient conditions, or when no one is in the room.

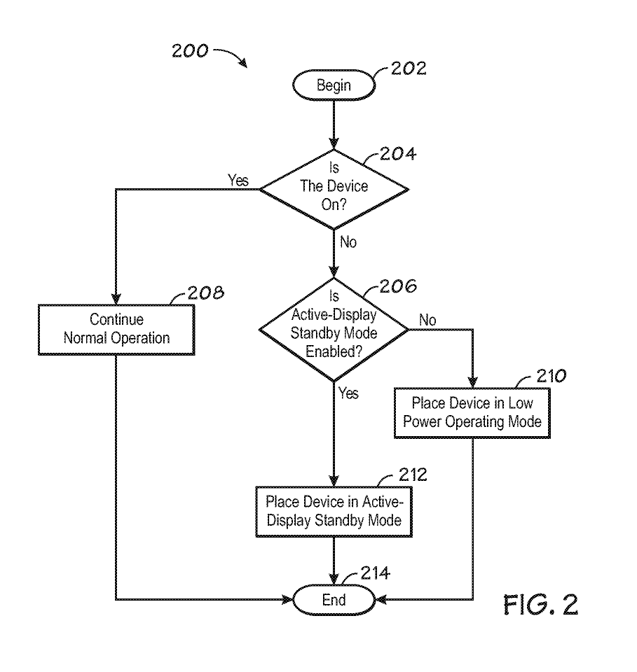

FIG. 2 is a process flow diagram illustrating a method in accordance with an exemplary embodiment of the present invention. The process is generally referred to by the reference number 200. At block 202, the process begins.

At block 204, a determination is made about whether the electronic device 100 (FIG. 1) is turned on. If the electronic device 100 (FIG. 1) is turned on, normal operation of the device continues with all device subsystems powered, as shown at block 208. The process then ends at block 214.

If the electronic device 100 (FIG. 1) is no longer turned on at block 204 (e.g., the user of the device has issued a command to turn the device off), a determination is made about whether the active-display standby mode has been enabled for the electronic device 100 (FIG. 1). If the active-display standby mode has not been enabled, the low power control logic 116 (FIG. 1) places the electronic device 100 (FIG. 1) into the low power operating mode, as shown at block 210. In the low power operating mode, power is removed from all major subsystems of the electronic device 100 (FIG. 1), including the display subsystem 114 (FIG. 1). Thereafter, the process ends at block 214.

If the active-display standby mode is determined to be enabled at block 206, the low power control logic 116 (FIG. 1) places the electronic device 100 (FIG. 1) into the active-display standby mode. In the active-display standby mode the display subsystem 114 (FIG. 1) remains powered on and the low power control logic 116 removes power from at least one other subsystem (e.g., the tuner subsystem 104 (FIG. 1) and/or the audio subsystem 108 (FIG. 1)). After the electronic device 100 (FIG. 1) is placed into the active-display standby mode at block 212, the process ends at block 214. As set forth above, display of video data from alternative sources on the display subsystem 114 is enabled when the electronic device 100 is in the active-display standby mode.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic device, comprising:
a display subsystem that is adapted to display an image;
at least one additional subsystem; and
a low power control logic that is adapted to place the electronic device in either a low power operating mode in which power is removed from the display subsystem and the at least one additional subsystem or an active-display standby mode in which the display subsystem remains powered and power is removed from the at least one additional subsystem.

2. The electronic device recited in claim 1, wherein, if the electronic device is in the active-display standby mode, the low power control logic is adapted to determine whether the at least one additional subsystem is needed for display of video data prior to removing power from the at least one additional subsystem.

3. The electronic device recited in claim 1, wherein the active-display standby mode is operative during a user-selected time period.

4. The electronic device recited in claim 1, wherein the electronic device displays video images received via a signal source input when in the active-display standby mode.

5. The electronic device recited in claim 1, wherein the electronic device displays video images received via a computer interface when in the active-display standby mode.

6. The electronic device recited in claim 1, wherein the electronic device displays a digital photograph when in the active-display standby mode.

7. The electronic device recited in claim 1, wherein the electronic device displays a closed-circuit television feed when in the active-display standby mode.

8. The electronic device recited in claim 1, wherein the electronic device displays video data received via a wireless camera when in the active-display standby mode.

9. The electronic device recited in claim 1, wherein the electronic device displays a video conference when in the active-display standby mode.

10. The electronic device recited in claim 1, wherein the electronic device displays video data received via the Internet when in the active-display standby mode.

11. A method of operating an electronic device, comprising:
placing the electronic device into an active-display standby mode in which a display subsystem remains powered and power is removed from at least one additional subsystem of the electronic device if the active-display standby mode is enabled by a user; and
placing the electronic device in a low power operating mode in which power is removed from the display subsystem and the at least one additional subsystem of the electronic device if the active-display standby mode is not enabled by the user.

12. The method recited in claim 11, comprising determining whether the at least one additional subsystem is needed for display of video data prior to removing power from the at least one additional subsystem if the electronic device is in the active-display standby mode.

13. The method recited in claim 11, comprising placing the electronic device into the active-display standby mode during a user-selected time period.

14. The method recited in claim 11, comprising displaying video images received via a signal source input during the active-display standby mode.

15. The method recited in claim 11, comprising displaying video images received via a computer interface during the active-display standby mode.

16. The method recited in claim 11, comprising displaying a digital photograph during the active-display standby mode.

17. The method recited in claim 11, comprising displaying a closed-circuit television feed during the active-display standby mode.

18. The method recited in claim 11, comprising receiving video data via a wireless camera during the active-display standby mode.

19. The method recited in claim 11, comprising displaying video data received via the Internet when in the active-display standby mode.

20. An electronic device, comprising:
means for placing the electronic device into an active-display standby mode in which a display subsystem remains powered and power is removed from at least one additional subsystem of the electronic device if the active-display standby mode is enabled by a user; and
means for placing the electronic device in a low power operating mode in which power is removed from the display subsystem and the at least one additional subsystem of the electronic device if the active-display standby mode is not enabled by the user.
